(19) United States
(12) Patent Application Publication
(10) Pub. No.: US 2017/0305339 A1
(43) Pub. Date: Oct. 26, 2017

(54) LUMINOUS CURTAIN DEVICE

(71) Applicant: MACAUTO INDUSTRIAL CO., LTD., Tainan City (TW)

(72) Inventors: Paul LIN, Tainan City (TW); Hung-Ming YEN, Tainan City (TW); Wei-Ting CHEN, Tainan City (TW); Yu-Hsien CHIEN, Tainan City (TW); Chien-Wen CHEN, Tainan City (TW); Chao-Cheng CHU, Tainan City (TW); Li-Wen YANG, Tainan City (TW)

(73) Assignee: MACAUTO INDUSTRIAL CO., LTD., Tainan City (TW)

(21) Appl. No.: 15/402,896

(22) Filed: Jan. 10, 2017

(30) Foreign Application Priority Data
Apr. 20, 2016 (CN) 201620333321.8

(51) Int. Cl. B60Q 3/208; F21V 8/00; B60J 7/00; B60J 1/20; B60Q 3/64; F21S 4/28

(52) U.S. Cl. CPC B60Q 3/208; G02B 6/0068; G02B 6/001; F21S 4/28; B60J 1/2013; B60Q 3/64; B60J 7/0015

(57) ABSTRACT

A luminous curtain device has a luminous curtain, a side member, and a luminous module. The side member is mounted on a side of the luminous curtain. The luminous module is mounted in the side member, and projects light on ends of optical fibers of the luminous curtain. The luminous curtain device is applied on sunlight-shading products for an automobile to shade sunlight. The luminous module can project light on the luminous curtain to make the luminous curtain luminous with a decorative effect.

### BACKGROUND OF THE INVENTION

### 1. Field of the Invention

The present invention relates to a luminous curtain device, and more particularly to a luminous curtain device that is applied on a sunroof sunshade, a side window sunshade, a rear glass sunshade, and a rear space sunshade of an automobile, and has a luminous effect.

### 2. Description of Related Art

To avoid sunlight directly projecting into an interior of an automobile, or to shade a rear space of the automobile, various types of conventional curtain devices applied on a sunroof sunshade, a side window sunshade, a rear glass sunshade, and the rear space sunshade of the automobile are provided for users.

The conventional curtain device is provided with a dark curtain to shade the sunlight or the rear space of the automobile. The dark curtain is made of a soft object, such as a fabric, such that the dark curtain can be operated to be expanded or wounded. However, the dark curtain only has a single function, which is to shade the sunlight. In addition, in the conventional art, research and development of the curtain device is focused on shading the sunlight. Besides, in terms of figures and patterns, the dark curtain is mostly plain and provides very basic decoration. Therefore, the conventional curtain devices are highly monotonous and have little distinction and differentiation from one another. To increase competitiveness of curtain devices and highlight diversities, the conventional curtain devices need to be improved.

### SUMMARY OF THE INVENTION

The main objective of the present invention is to provide a luminous curtain device to resolve the problems of the conventional curtain device.

The luminous curtain device has a luminous curtain, a side member, and a luminous module.

The luminous curtain is implemented as a fabric and comprises multiple optical fibers, a first end, and a second end opposite the first end, wherein the optical fibers extend toward the first end.

The side member is elongated, and comprises a clamping portion and a mounting space. The clamping portion is located on a long side of the side member, and comprises a clamping slit formed and extending in the clamping portion, wherein the first end is inserted into the clamping slit. The mounting space is formed in the side member and communicates with the clamping slit, and ends of the optical fibers of the luminous curtain face toward the mounting space.

The luminous module is mounted in the mounting space of the side member, and comprises a luminous part facing toward the ends of the optical fibers of the luminous curtain.

Other objectives, advantages and novel features of the present invention will become more apparent from the following detailed description when taken in conjunction with the accompanying drawings.

### BRIEF DESCRIPTION OF THE DRAWINGS

FIG. 1A is a perspective view of a first preferred embodiment of a luminous curtain device in accordance with the present invention;

FIG. 1B is a partially enlarged perspective view of the luminous curtain device in FIG. 1A;

FIG. 2A is a partially enlarged exploded perspective view of the luminous curtain device in FIG. 1A;

FIG. 2B shows arrangement of optical fibers of a luminous curtain of the luminous curtain device in FIG. 1A;

FIG. 3 is an enlarged side view in partial section of the luminous curtain device in FIG. 1A;

FIG. 4A is a perspective view of a second preferred embodiment of the luminous curtain device in accordance with the present invention;

FIG. 4B is a partially enlarged perspective view of the luminous curtain device in FIG. 4A;

FIG. 5A is a partially enlarged exploded perspective view of the luminous curtain device in FIG. 4A;

FIG. 5B shows arrangement of optical fibers of a luminous curtain of the luminous curtain device in FIG. 5A;

FIG. 6 is an enlarged side view in partial section of the luminous curtain device in FIG. 4;

FIG. 7 is an operational top view of the luminous curtain device in FIG. 1; and

FIG. 8 is an operational side view of the luminous curtain device in FIG. 1.

### DETAILED DESCRIPTION OF PREFERRED EMBODIMENT

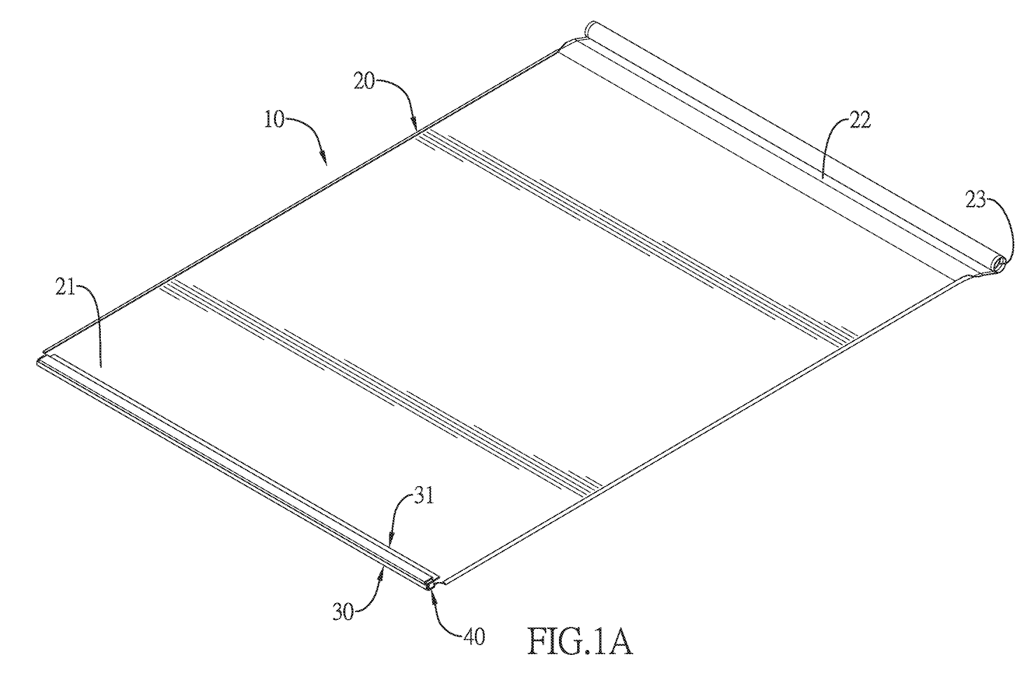

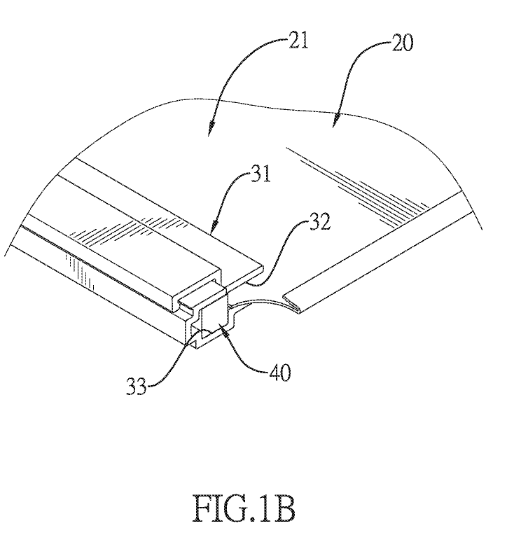

With reference to FIGS. 1A to 3, a first preferred embodiment of a luminous curtain device 10 in accordance with the present invention comprises a luminous curtain 20, a side member 30, and a luminous module 40.

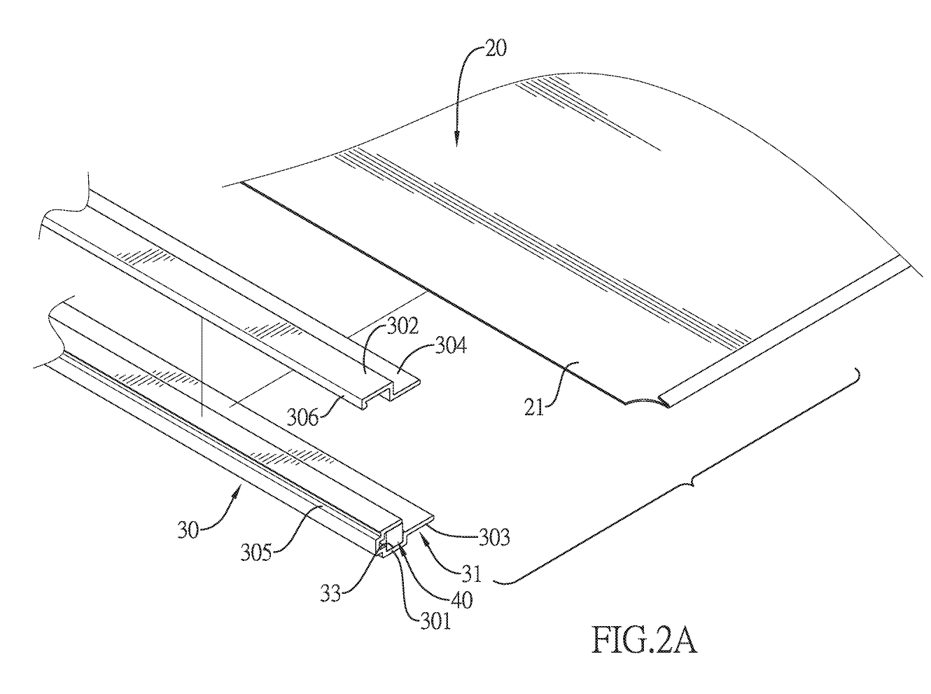

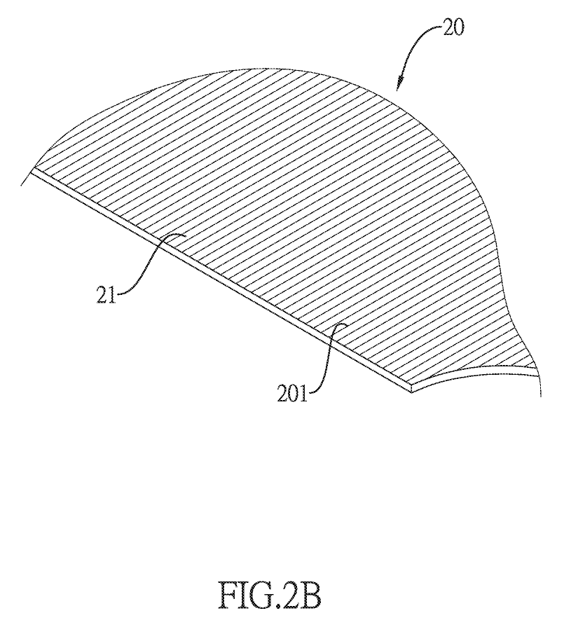

With reference to FIGS. 1A to 3, the luminous curtain 20 may be a fabric having multiple optical fibers 201, as shown in FIG. 2B. Preferably, the luminous curtain 20 comprises multiple optical fibers 201 and multiple dark yarns woven with the optical fibers 201 to form the luminous curtain 20, such that the luminous curtain 20 can have a shading function. The luminous curtain 20 can be passively luminous via the optical fibers 201 transmitting light or diffusing light. Arrangement of the optical fibers 201 of the luminous curtain 20 depends on the product demand. The luminous curtain 20 comprises a first end 21 and a second end 22 opposite the first end 21. The optical fibers 201 extend toward the first end 21, preferably from the second end 22. The second end 22 can be further connected with a shaft 23, such that the luminous curtain 20 can be rolled around the shaft 23 to be wound on the shaft 23.

With reference to FIGS. 1 to 3, the side member 30 is connected with the first end 21 of the luminous curtain 20. The side member 30 is hollow and elongated and comprises a clamping portion 31 located on a long side of the side member 30. The clamping portion 31 comprises a clamping slit 32 formed and extending in the clamping portion 31. The first end 21 of the luminous curtain 20 is inserted into the clamping slit 32. The side member 30 further comprises a mounting space 33 formed in the side member 30 and communicating with the clamping slit 32, such that the luminous curtain 20 is inserted into the clamping slit 32, and ends of the optical fibers 201 of the luminous curtain 20 face toward the mounting space 33.

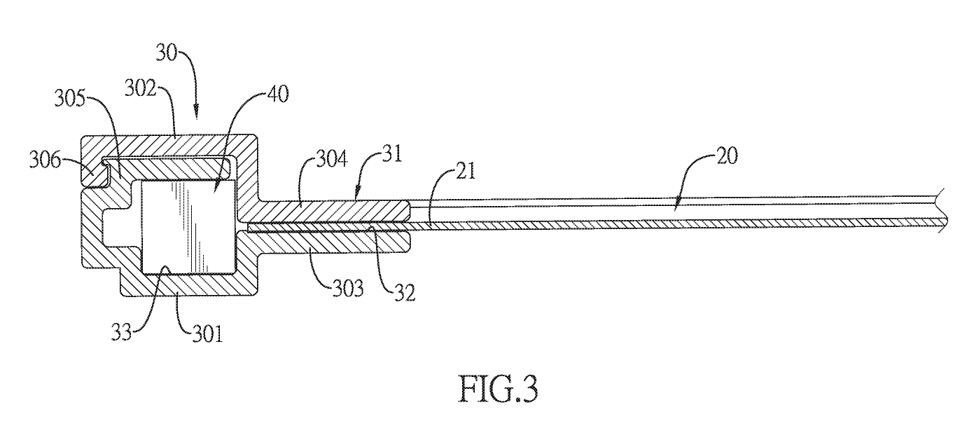

The side member 30 may be formed as an integral element. Alternatively, the side member 30 comprises a first part 301 and a second part 302 combined with each other, as shown in FIGS. 2 and 3. The first part 301 comprises two ends, a first clamping plate 303 located at one of the two ends of the first part 301, and a first engagement body 305 located at the other end of the first part 301, such that the first clamping plate 303 and the first engagement body 305 are opposite each other. The second part 302 comprises two ends, a second clamping plate 304 located at one of the two ends of the second part 302, and a second engagement body 306 located at the other end of the second part 302, such that the second clamping plate 304 and the second engagement body 306 are opposite each other. The first part 301 and the second part 302 are combined with each other, wherein the first engagement body 305 and the second engagement body 306 are engaged with each other, and the first clamping plate 303 and the second clamping plate 304 are arranged opposite each other to form the clamping slit 32 therebetween.

The luminous module 40 is mounted in the mounting space 33 of the side member 30, and comprises a luminous part facing toward the ends of the optical fibers 201 of the luminous curtain 20 to project light on the optical fibers 201. The luminous module 40 may be electrically connected with an external power supply. Alternatively, a battery can be mounted in the mounting space 33 of the side member 30 to provide electricity for the luminous module 40. Preferably, the luminous module 40 is implemented as a low-power light emitting diode light bar. A lighting portion of the light emitting diode light bar faces toward the first end 21 located in the clamping slit 32 of the side member 30, such that light emitted by the luminous module 40 can project on the luminous curtain 20. Further, the luminous curtain 20 can be passively luminous via the optical fibers 201 transmitting light or diffusing light. The luminous module 40 can emit monochromatic light or polychromatic light. When the luminous module 40 emits polychromatic light, the luminous module 40 can be controlled to select a color mode of the light to generate variations.

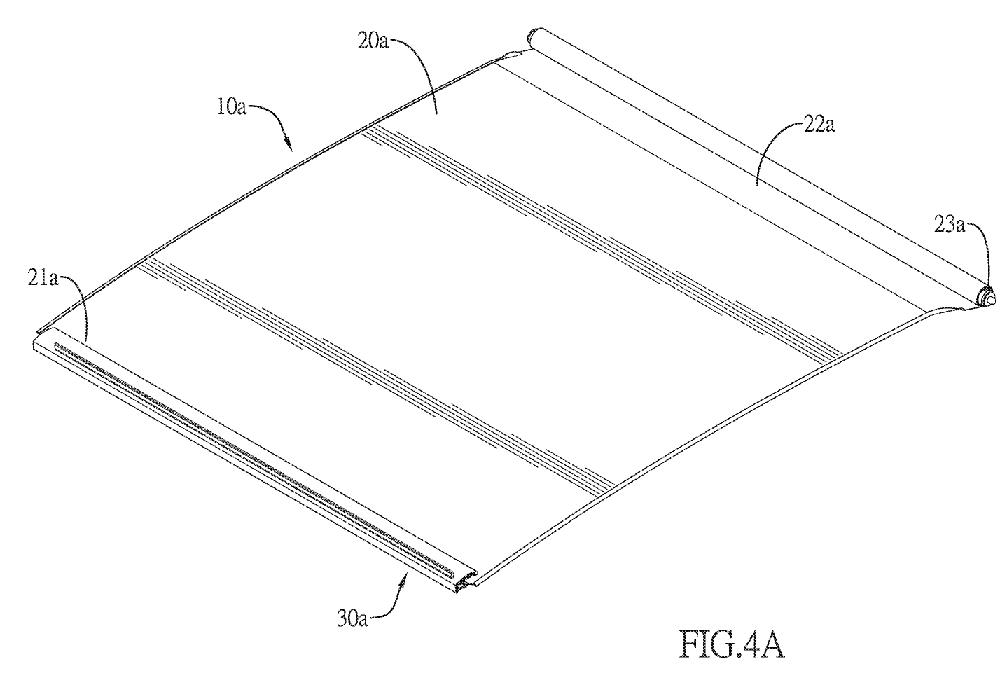

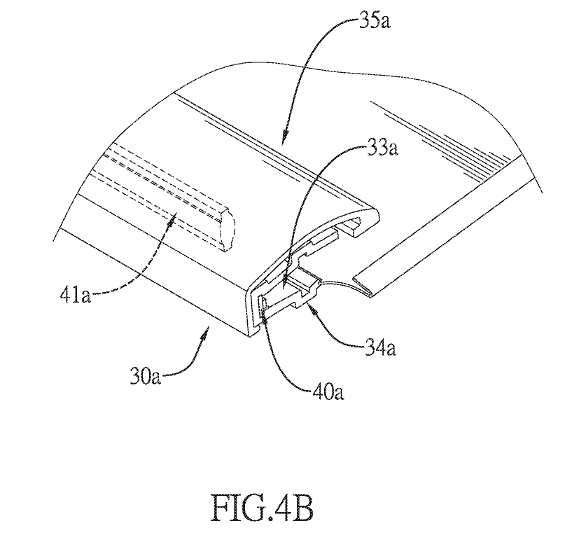

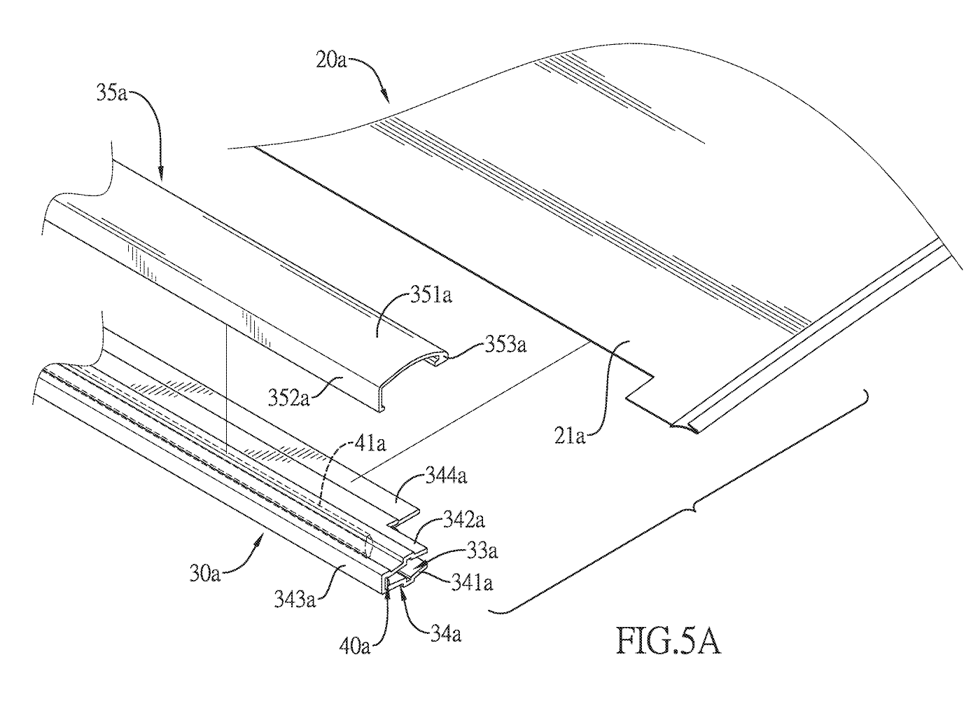

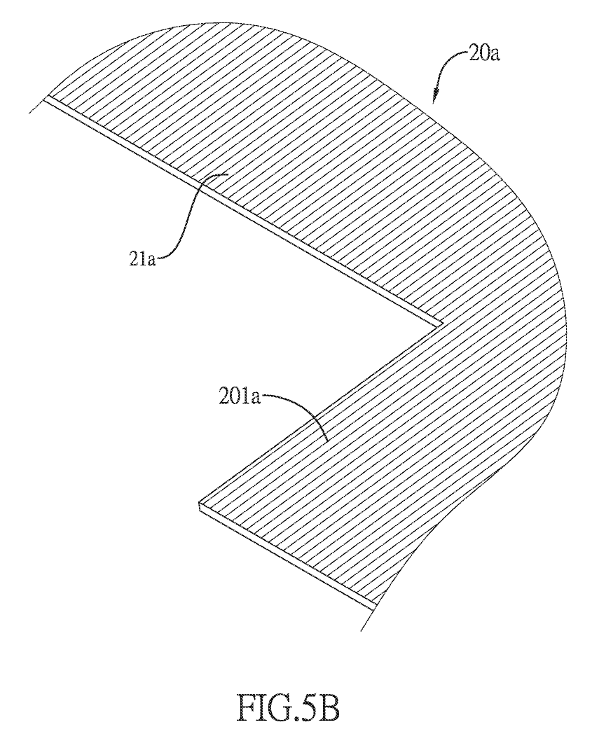

With reference to FIGS. 4 to 6, a second preferred embodiment of a luminous curtain device 10a comprises a luminous curtain 20a, a side member 30a, and a luminous module 40a.

The luminous curtain 20a may be a fabric having multiple optical fibers 201a. Preferably, the luminous curtain 20a comprises multiple optical fibers 201a and multiple dark yarns woven with the optical fibers 201a to form the luminous curtain 20a, such that the luminous curtain 20a can have a shading function. The luminous curtain 20a can be passively luminous via the optical fibers 201a transmitting light or diffusing light. The luminous curtain 20a comprises a first end 21a and a second end 22a opposite the first end 21a. The optical fibers 201a extend toward the first end 21a. Arrangement of the optical fibers 201a of the luminous curtain 20a depends on product demand, such that when the luminous curtain 20a is passively luminous, a pattern is formed on the luminous curtain 20a. The second end 22a can be connected with a shaft 23a, such that the luminous curtain 20a can be rolled in the shaft 23a, or be extracted and spread from the shaft 23a.

The side member 30a is hollow and elongated, and is connected with the first end 21a of the luminous curtain 20a. The side member 30a comprises a mounting space 33a formed in the side member 30a, and a clamping portion 31a located on a long side of the side member 30a. The clamping portion 31a comprises a clamping slit 32a formed and extending in the clamping portion 31a. The first end 21a of the luminous curtain 20a is inserted into and fixed in the clamping slit 32a, such that ends of the optical fibers 201a of the luminous curtain 20a can face toward the mounting space 33a.

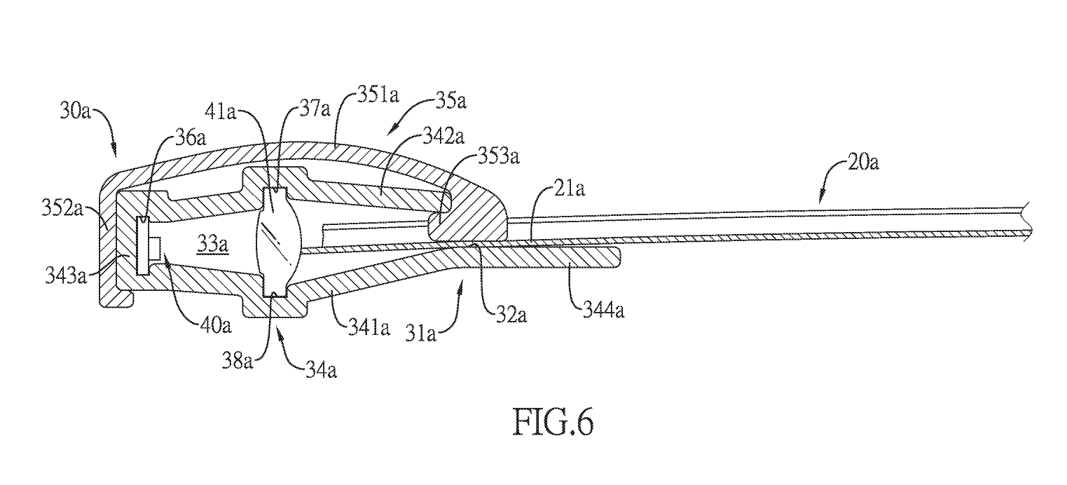

Preferably, the side member 30a comprises a side body 34a and a fixing body 35a combined with the side body 34a. The side body 34a comprises a first piece 341a, a second piece 342a, and an end piece 343a. The first piece 341a and the second piece 342a are arranged at a spaced interval, as shown in FIG. 6. The end piece 343a is connected between a side of the first piece 341a and a side of the second piece 342a. The mounting space 33a is formed between the first piece 341a, the second piece 342a, and the end piece 343a. The first piece 341a further comprises a clamping part 344a opposite the end piece 343a. The side member 30a further comprises an embedding recess 36a recessed in connecting portions between the end piece 343a and the first and second pieces 341a, 342a and communicating with the mounting space 33a. The first and second pieces 341a, 342a each further comprise a respective engagement recess 37a, 38a, and the two engagement recesses 37a, 38a are respectively recessed in middles of the first, second pieces 341a, 342a, are aligned with each other, and communicate with the mounting space 33a. The fixing body 35a comprises a cover 351a, an assisting piece 352a, and an engagement piece 353a. The assisting piece 352a and the engagement piece 353a are respectively connected with two ends of the cover 351a. The fixing body 35a is mounted on the side body 34a. The cover 351a covers the second piece 342a. The assisting piece 352a is engaged with the end piece 343a of the side body 34a, and the engagement piece 353a is engaged with an end of the second piece 342a opposite the end piece 343a. The clamping slit 32a is formed between the engagement piece 353a and the clamping part 344a, and the engagement piece 353a and the clamping part 344a clamp the first end 21a of the luminous curtain 20a.

The luminous module 40a may be implemented as a light emitting diode light bar that can emit monochromatic light or polychromatic light. When the luminous module 40a emits polychromatic light, the luminous module 40a can be controlled to select a color mode of the light to generate lighting variations. The luminous module 40a is mounted in the mounting space 33a of the side member 30a. A luminous part of the luminous module 40a faces toward the ends of the optical fibers 201a of the luminous curtain 20a to project light on the optical fibers 201a. Preferably, the luminous module 40a is implemented as the light emitting diode light bar mounted in and positioned in the embedding recess 36a of the side body 34a of the side member 30a. The luminous module 40a may be electrically connected with an external power supply. Alternatively, a battery can be mounted in the mounting space 33a of the side member 30a to provide electricity for the luminous module 40a.

A light-guiding plate 41a is mounted in the mounting space 33a of the side member 30a, and is located between the first end 21a of the luminous curtain 20a and the luminous module 40a, such that light emitted by the luminous module 40a can be focused on the first end 21a of the luminous curtain 20a. Then, the optical fibers 201a of the luminous curtain 20a will guide light or diffuse light to make the luminous curtain 20a passively luminous. Preferably, the light-guiding plate 41a is embedded in and positioned in the engagement recesses 37a, 38a of the first and second pieces 341a, 342a.

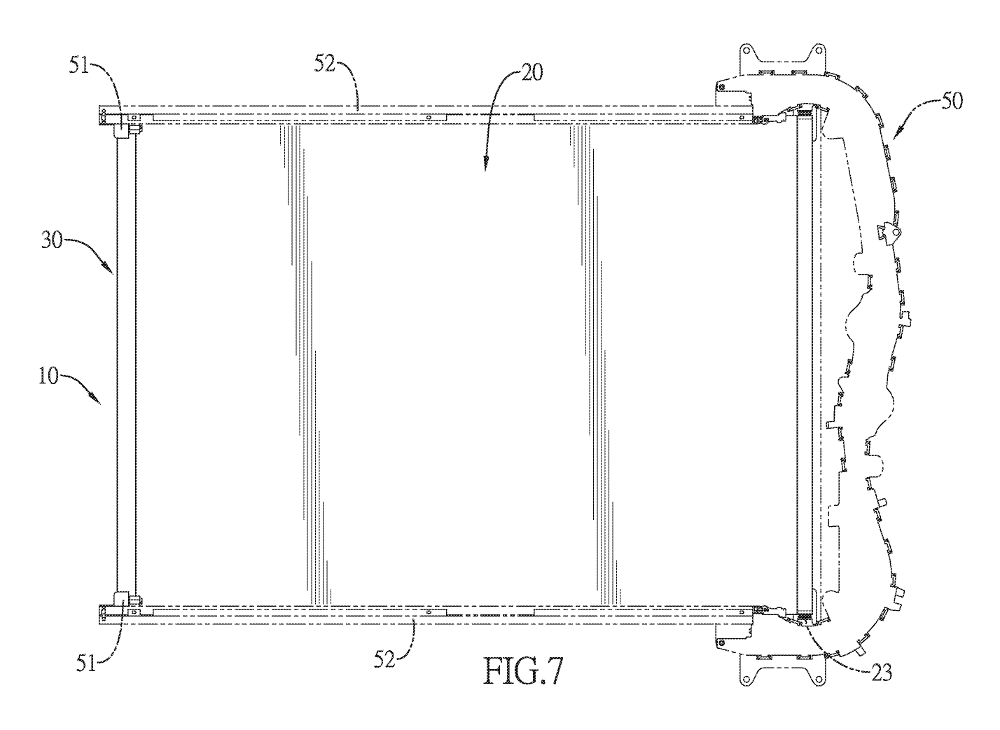

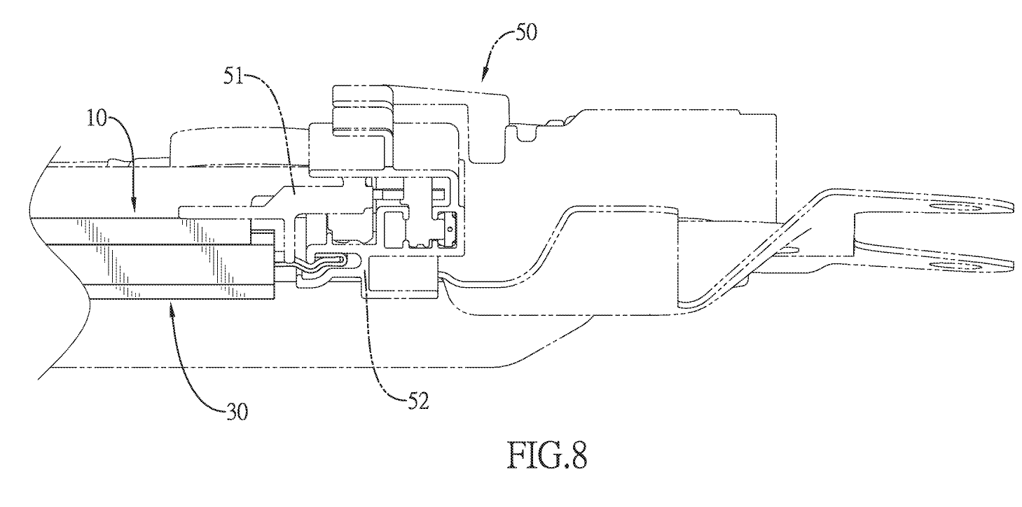

The luminous curtain device 10, 10a can be applied on a sunroof sunshade, a side window sunshade, a rear glass sunshade, and a rear space sunshade of an automobile. With reference to FIGS. 1, 7 and 8, the luminous curtain device 10 is mounted on a frame 50 of a sunroof. The shaft 23 assembled with the second end 22 of the luminous curtain 20 is combined with a retractor, and is mounted on a side of the frame 50. Two guiding blocks 51 are respectively mounted on two ends of the side member 30, which is assembled with the first end 21 of the luminous curtain 20, and the guiding blocks 51 are respectively mounted on two opposite guiding tracks 52 of the frame 50, such that the luminous curtain 20 can be slid on the guiding tracks 52 by the guiding blocks 51. Cooperating with the retractor in the shaft 23, the luminous curtain 20 can be expanded or recoiled relative to the frame 50. Therefore, the luminous curtain device 10 can provide a basic sunlight-blocking function by the luminous curtain 20. In addition, the luminous module 40 mounted in the side member 30 can directly project light on the ends of the optical fibers 201a of the luminous curtain 20, as shown in FIG. 3. Alternatively, light emitted by the luminous module 40a can be transmitted by the light-guiding plate 41a to indirectly project on the ends of the optical fibers 201a of the luminous curtain 20a, as shown in FIG. 6. Then, the light can be transmitted or diffused by the optical fibers 201a to make the luminous curtain 20, 20a passively luminous. Therefore, the luminous curtain device 10, 10a can provide soft lighting to an interior of the automobile for decoration.

From the above description, it is noted that the present invention has the following advantages:

1. The luminous curtain device 10, 10a can be applied on the sunroof sunshade, the side window sunshade, the rear glass sunshade, and the rear space sunshade of the automobile. The luminous curtain device 10, 10a can provide the basic sunlight-blocking function by the luminous curtain 20, 20a. In addition, the luminous module 40, 40a mounted in the side member 30, 30a can project light on the ends of the optical fibers 201, 201a of the luminous curtain 20, 20a. The light can be guided or diffused by the optical fibers 201, 201a to make the luminous curtain 20, 20a luminous. Therefore, the luminous curtain device 10, 10a can provide soft lighting to the interior of the automobile for decoration via the light projected on the luminous curtain 20, 20a. At the same time, a manufacturer can arrange the optical fibers 201, 201a of the luminous curtain 20, 20a to cooperate with the light of the luminous module 40, 40a to change a design of the luminous curtain device 10, 10a, or the manufacturer can custom-make the design depending on demand for product diversification.

2. The light-guiding plate 41a is mounted in the side member 30a, and is located between the ends of the optical fibers 201a of the luminous curtain 20a and the luminous module 40a, such that light emitted by the luminous module 40a can be focused on the ends of the optical fibers 201a of the luminous curtain 20a via guiding of the light-guiding plate 41a to increase brightness and uniformity of the passive luminousness of the luminous curtain 20a.

3. The side member 34a further comprises the embedding recess 36a recessed in connecting portions between the end piece 343a and the first and second pieces 341a, 342a, such that the luminous module 40a can be mounted in the embedding recess 36a. On the other hand, the light-guiding plate 41a can be positioned in the engagement recess 37a, 38a.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A luminous curtain device comprising:
a luminous curtain implemented as a fabric and comprising multiple optical fibers, a first end, and a second end opposite the first end, wherein the optical fibers extend toward the first end;
a side member being elongated, and comprising
a clamping portion located on a long side of the side member, and comprising a clamping slit formed and extending in the clamping portion, wherein the first end is inserted into the clamping slit; and
a mounting space formed in the side member and communicating with the clamping slit, and ends of the optical fibers of the luminous curtain facing toward the mounting space; and
a luminous module mounted in the mounting space of the side member, and comprising a luminous part facing toward the ends of the optical fibers of the luminous curtain.

2. The luminous curtain device as claimed in claim 1, wherein the second end of the luminous curtain is connected with a shaft, and the luminous curtain is selectively rolled around the shaft.

3. The luminous curtain device as claimed in claim 1, wherein
the side member comprises a first part and a second part combined with each other;
the first part comprises two ends, a first clamping plate located at one of the two ends of the first part, and a first engagement body located at the other end of the first part, such that the first clamping plate and the first engagement body are opposite each other;
the second part comprises two ends, a second clamping plate located at one of the two ends of the second part, and a second engagement body located at the other end of the second part, such that the second clamping plate and the second engagement body are opposite each other; and
the first engagement body and the second engagement body are engaged with each other, and the first clamping plate and the second clamping plate are arranged opposite each other to form the clamping slit therebetween.

4. The luminous curtain device as claimed in claim 2, wherein
the side member comprises a first part and a second part combined with each other;
the first part comprises two ends, a first clamping plate located at one of the two ends of the first part, and a first engagement body located at the other end of the first part, such that the first clamping plate and the first engagement body are opposite each other;
the second part comprises two ends, a second clamping plate located at one of the two ends of the second part, and a second engagement body located at the other end of the second part, such that the second clamping plate and the second engagement body are opposite each other; and
the first engagement body and the second engagement body are engaged with each other, and the first clamping plate and the second clamping plate are arranged opposite each other to form the clamping slit therebetween.

5. The luminous curtain device as claimed in claim 1, wherein the luminous module is implemented as a light emitting diode light bar, and a lighting portion of the light emitting diode light bar faces toward the ends of the optical fibers of the luminous curtain located in the clamping slit of the side member.

6. The luminous curtain device as claimed in claim 2, wherein the luminous module is implemented as a light emitting diode light bar, and a lighting portion of the light emitting diode light bar faces toward the ends of the optical fibers of the luminous curtain located in the clamping slit of the side member.

7. The luminous curtain device as claimed in claim 3, wherein the luminous module is implemented as a light emitting diode light bar, and a lighting portion of the light emitting diode light bar faces toward the ends of the optical fibers of the luminous curtain located in the clamping slit of the side member.

8. The luminous curtain device as claimed in claim 4, wherein the luminous module is implemented as a light emitting diode light bar, and a lighting portion of the light emitting diode light bar faces toward the ends of the optical fibers of the luminous curtain located in the clamping slit of the side member.

9. The luminous curtain device as claimed in claim 1, wherein
the luminous module is implemented as a light emitting diode light bar, and a lighting portion of the light emitting diode light bar faces toward the ends of the optical fibers of the luminous curtain located in the clamping slit of the side member; and
a light-guiding plate is mounted in the mounting space of the side member, and is located between the ends of the optical fibers of the luminous curtain and the luminous module.

10. The luminous curtain device as claimed in claim 2, wherein the luminous module is implemented as a light emitting diode light bar, and a lighting portion of the light emitting diode light bar faces toward the ends of the optical fibers of the luminous curtain located in the clamping slit of the side member; and
a light-guiding plate is mounted in the mounting space of the side member, and is located between the ends of the optical fibers of the luminous curtain and the luminous module.

11. The luminous curtain device as claimed in claim 1, wherein
the side member comprises
a side body comprising a first piece, a second piece, and an end piece connected between a side of the first piece and a side of the second piece, wherein the first piece and the second piece are arranged at a spaced interval, and the mounting space is formed between the first piece, the second piece, and the end piece, wherein the first piece further comprises a clamping part opposite the end piece;
a fixing body combined with the side body, and comprising a cover, an assisting piece, and an engagement piece;
the assisting piece and the engagement piece respectively connected with two sides of the cover;
the cover covering the second piece;
the assisting piece engaged with the end piece of the side body, and the engagement piece engaged with a side of the second piece opposite the end piece; and
the clamping slit formed between the engagement piece and the clamping part, and the engagement piece and the clamping part clamping the first end of the luminous curtain.

12. The luminous curtain device as claimed in claim 2, wherein
the side member comprises
a side body comprising a first piece, a second piece, and an end piece connected between a side of the first piece and a side of the second piece, wherein the first piece and the second piece are arranged at a spaced interval, and the mounting space is formed among the first piece, the second piece, and the end piece, wherein the first piece further comprises a clamping part opposite the end piece;
a fixing body combined with the side body, and comprising a cover, an assisting piece, and an engagement piece;
the assisting piece and the engagement piece respectively connected with two sides of the cover;
the cover covering the second piece;
the assisting piece engaged with the end piece of the side body, and the engagement piece engaged with a side of the second piece opposite the end piece; and
the clamping slit formed between the engagement piece and the clamping part, and the engagement piece and the clamping part clamping the first end of the luminous curtain.

13. The luminous curtain device as claimed in claim 11, wherein the luminous module is implemented as a light emitting diode light bar, and a lighting portion of the light emitting diode light bar faces toward the ends of the optical fibers of the luminous curtain located in the clamping slit of the side member.

14. The luminous curtain device as claimed in claim 12, wherein the luminous module is implemented as a light emitting diode light bar, and a lighting portion of the light emitting diode light bar faces toward the ends of the optical fibers of the luminous curtain located in the clamping slit of the side member.

15. The luminous curtain device as claimed in claim 11, wherein the luminous module is implemented as a light emitting diode light bar, and a lighting portion of the light emitting diode light bar faces toward the ends of the optical fibers of the luminous curtain located in the clamping slit of the side member; and
a light-guiding plate is mounted in the mounting space of the side member, and is located between the ends of the optical fibers of the luminous curtain and the luminous module.

16. The luminous curtain device as claimed in claim 12, wherein the luminous module is implemented as a light emitting diode light bar, and a lighting portion of the light emitting diode light bar faces toward the ends of the optical fibers of the luminous curtain located in the clamping slit of the side member; and
a light-guiding plate is mounted in the mounting space of the side member, and is located between the ends of the optical fibers of the luminous curtain and the luminous module.

17. The luminous curtain device as claimed in claim 11, wherein
the side member further comprises an embedding recess recessed in connecting portions between the end piece and the first and second pieces and communicating with the mounting space;
the first and second pieces each further comprise a respective engagement recess, and the two engagement recesses are respectively recessed in middles of the first and second pieces;
the luminous module is implemented as a light emitting diode light bar mounted in and positioned in the embedding recess of the side body of the side member;
a lighting portion of the light emitting diode light bar faces toward the ends of the optical fibers of the luminous curtain located in the clamping slit of the side member; and
a light-guiding plate is mounted in the mounting space of the side member, is located between the ends of the optical fibers of the luminous curtain and the luminous module, and is embedded in and positioned in the engagement recesses of the first and second pieces.

18. The luminous curtain device as claimed in claim 12, wherein
the side member further comprises an embedding recess recessed in connecting portions between the end piece and the first and second pieces and communicating with the mounting space;
the first and second pieces each further comprise an engagement recess, and the two engagement recess are respectively recessed in middles of the first and second pieces;
the luminous module is implemented as a light emitting diode light bar mounted in and positioned in the embedding recess of the side body of the side member;
a lighting portion of the light emitting diode light bar faces toward the ends of the optical fibers of the luminous curtain located in the clamping slit of the side member; and
a light-guiding plate is mounted in the mounting space of the side member, is located between the ends of the optical fibers of the luminous curtain and the luminous module, and is embedded in and positioned in the engagement recesses of the first and second pieces.
